(19) United States
(12) Patent Application Publication
(10) Pub. No.: US 2018/0024721 A1
(43) Pub. Date: Jan. 25, 2018

(54) INFORMATION PROCESSING DEVICE

(71) Applicant: DataCook, Inc., Tokyo (JP)

(72) Inventors: Hideyuki NAGAI, Tokyo (JP); Naoya HIRAI, Tokyo (JP)

(73) Assignee: DataCook, Inc., Tokyo (JP)

(21) Appl. No.: 15/538,753

(22) PCT Filed: Dec. 24, 2015
(86) PCT No.: PCT/JP2015/086018

§ 371 Date: Jun. 22, 2017

(30) Foreign Application Priority Data
Dec. 26, 2014 (JP) 2014-266481

(51) Int. Cl. G06F 3/0481; G06F 3/0484; G06T 11/20

(52) U.S. Cl. CPC G06F 3/04815; G06F 3/04817; G06T 11/206; G06F 3/04845; G06T 2200/04; G06T 2200/24

(57) ABSTRACT

The present invention addresses a problem of providing realization, in a user terminal, of a virtual data controller which makes it possible to intuitively manipulate and analyze large data such as big data. For this purpose, a server 2 that is the information processing device is provided with an iconization unit 42 for iconizing big data, and a data controller provision unit 43 for providing a user terminal 1 of a user with a virtual data controller which makes it possible to control the big data by an interaction with the icon from the user.

### TECHNICAL FIELD

The present invention relates to an information processing device that can achieve, on a user terminal, a virtual data controller that allows a vast amount of data, such as big data, to be intuitively operated and analyzed.

### BACKGROUND ART

Conventionally, there are devices for presenting an analyzed result of so-called big data (e.g., refer to Patent Document 1).

Patent Document 1: Japanese Unexamined Patent Application, Publication No. 2014-235723

### DISCLOSURE OF THE INVENTION

### Problems to be Solved by the Invention

However, it is difficult to say that the conventional devices including the one disclosed in Patent Document 1 can intuitively operate and analyze a vast amount of data, such as big data.

The present invention has been made in consideration of this situation. An object of the present invention is to achieve, on a user terminal, a virtual data controller that allows a vast amount of data, such as big data, to be intuitively operated and analyzed.

### Means for Solving the Problems

An information processing device according to one embodiment of the present invention, includes: an iconization unit configured to make big data into an icon; and a provision unit configured to provide a virtual data controller to a terminal of a user, the virtual data controller configured to control the big data with an interaction from the user with the icon.

### Effects of the Invention

According to the present invention, a virtual data controller that allows a vast amount of data, such as big data, to be intuitively operated and analyzed can be achieved on a user terminal.

### BRIEF DESCRIPTION OF THE DRAWINGS

FIG. 1 illustrates a configuration of an information processing system according to one embodiment of the present invention.

FIG. 2 is a block diagram of a hardware configuration of a server according to one embodiment of the present invention, in the information processing system in FIG. 1.

FIG. 3 is a functional block diagram of a functional configuration of the server including the hardware configuration in FIG. 2.

FIG. 4 is a diagram for specifically describing, with a case of circle, an outline of iconization of data and a data controller function achieved by a device according to the present embodiment.

FIGS. 5A to 5E are diagrams for specifically describing, with a case of triangle, the outline of the iconization of the data and the data controller function achieved by the device according to the present embodiment.

FIGS. 6A to 6E are diagrams for specifically describing, with a case of square, the outline of the iconization of the data and the data controller function achieved by the device according to the present embodiment.

FIG. 7 is a schematic diagram indicating that analysis visualization based on AI (artificial intelligence) allows more abstract graphics.

### PREFERRED MODE FOR CARRYING OUT THE INVENTION

Embodiments of the present invention will be described below with reference to the drawings.

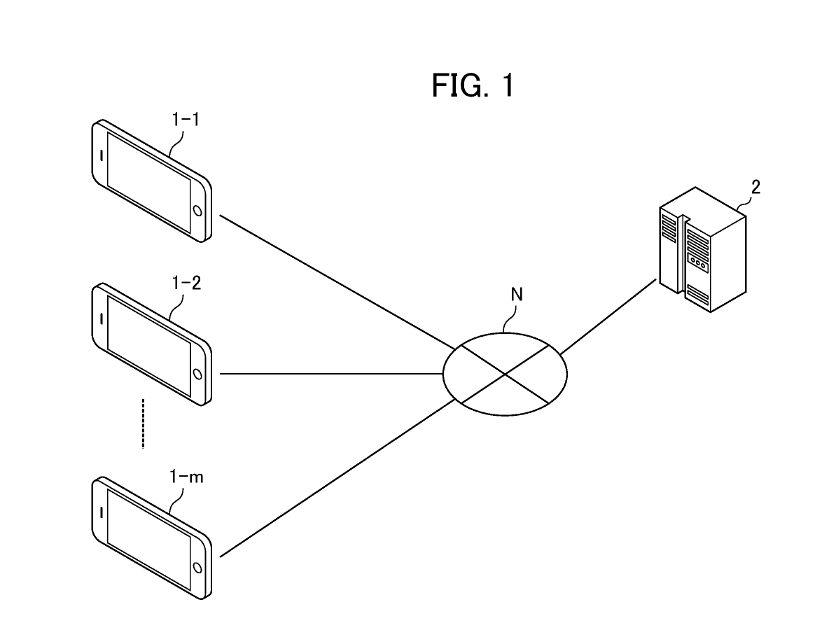

FIG. 1 illustrates a configuration of an information processing system according to one embodiment of the present invention. The information processing system illustrated in FIG. 1 includes user terminals 1-1 to 1-m used individually by m users (m is an arbitrary integer of 1 or more) and a server 2. Each of the user terminals 1-1 to 1-m and the server 2 are mutually connected through a predetermined network N, such as the Internet. Note that in a case where there is no need to individually distinguish the user terminals 1-1 to 1-m from each other, the user terminals are collectively referred to as a “user terminal 1”.

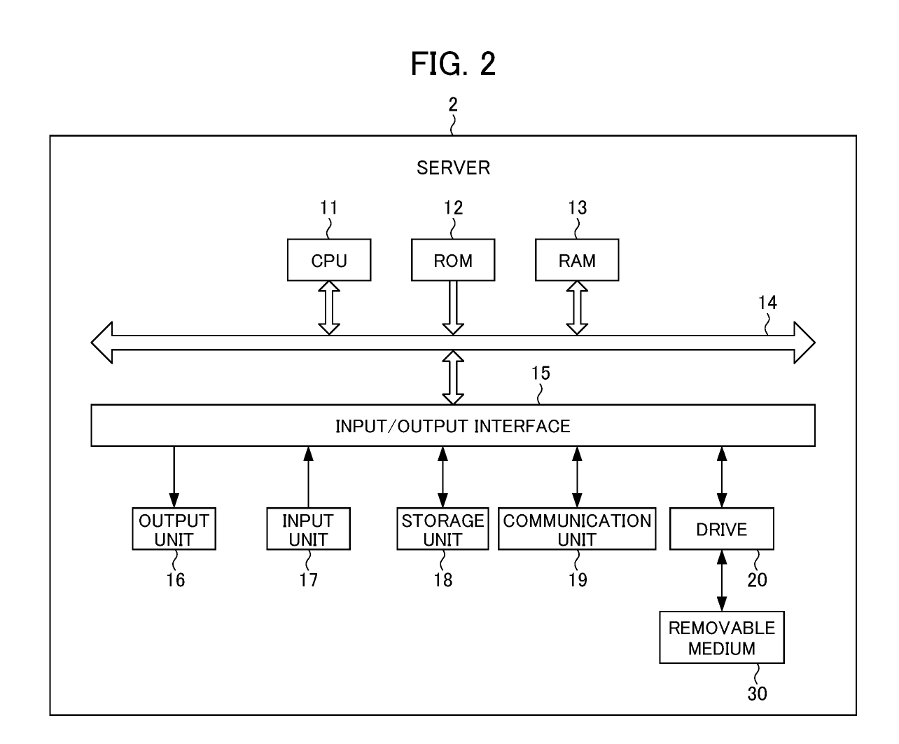

FIG. 2 is a block diagram of a hardware configuration of the server 2 according to one embodiment of the present invention in the information processing system in FIG. 1.

The server 2 includes a central processing unit (CPU) 11, a read only memory (ROM) 12, a random access memory (RAM) 13, a bus 14, an input/output interface 15, an output unit 16, an input unit 17, a storage unit 18, a communication unit 19, and a drive 20.

The CPU 11 performs various types of processing in accordance with a program stored in the ROM 12 or a program loaded from the storage unit 18 into the RAM 13. As necessary, the RAM 13 also stores, for example, data necessary for the CPU 11 to perform the various types of processing.

The CPU 11, the ROM 12, and the RAM 13 are mutually coupled through the bus 14. The input/output interface 15 is also coupled to the bus 14. The output unit 16, the input unit 17, the storage unit 18, the communication unit 19, and the drive 20 are coupled to the input/output interface 15.

The output unit 16 includes, for example, a speaker and a monitor to output various types of information in the form of sounds and images. The input unit 17 includes, for example, a keyboard to input various types of information in response to an instructed operation of a user. The storage unit 18 includes, for example, a hard disk and a dynamic random access memory (DRAM) to store various types of data. The communication unit 19 controls communication performed with a different device (the user terminal 1 in the example in FIG. 1) through the network N including the Internet.

The drive 20 is provided as necessary. A removable medium 30, such as a magnetic disk, an optical disc, a magneto-optical disc, or a semiconductor memory, is mounted on the drive 20 as necessary. A program read from the removable medium 30 by the drive 20 is, as necessary, installed into the storage unit 18. The removable medium 30 can store the various types of data stored in the storage unit 18, similarly to the storage unit 18.

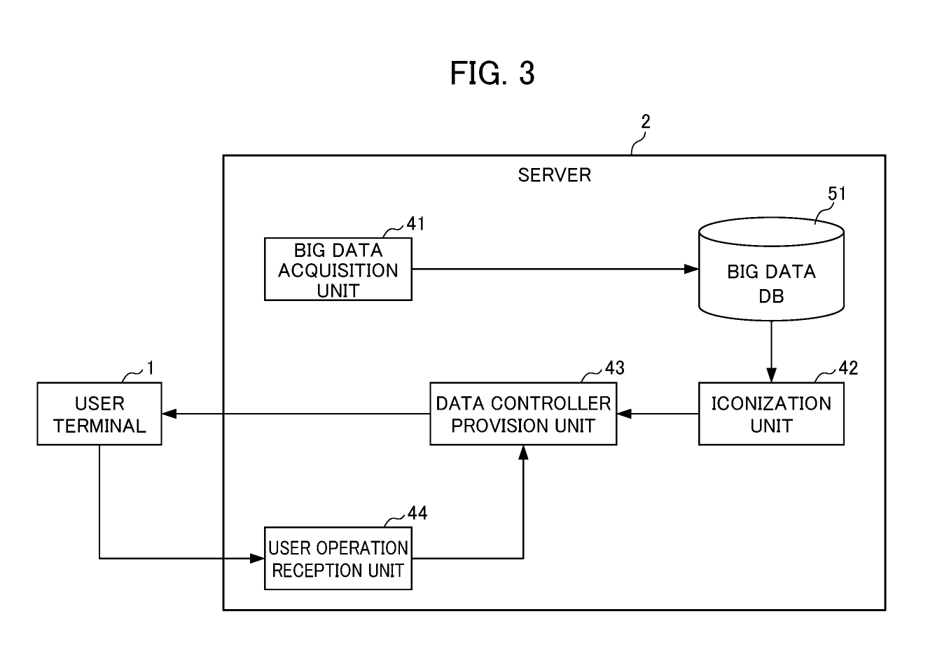

FIG. 3 is a functional block diagram of a functional configuration of the server 2 including the hardware configuration in FIG. 2. As illustrated in FIG. 3, each of a big data acquisition unit 41, an iconization unit 42, a data controller provision unit 43, and a user operation reception unit 44 achieves functions, for example, in the CPU 11 of the server 2. A big data DB 51 is provided in one area of the storage unit 18 in the server 2.

The big data acquisition unit 41 acquires big data from the network N connected to the Internet, to store the big data into the big data DB 51. The big data is referred to as data having at least one characteristic, such as data having a considerably large size, data including a plurality of mixed types, or data that is changed or updated at a high speed. Conventionally, an interface operated in order to totalize and analyze the big data tends to be quite intricate, and thus a large amount of time and efforts are required for the user to learn an operation method. Therefore, the server 2 according to the present embodiment includes the iconization unit 42, the data controller provision unit 43, and the user operation reception unit 44 in order to provide the function of a virtual data controller that allows the big data to be intuitively operated and analyzed, as described below.

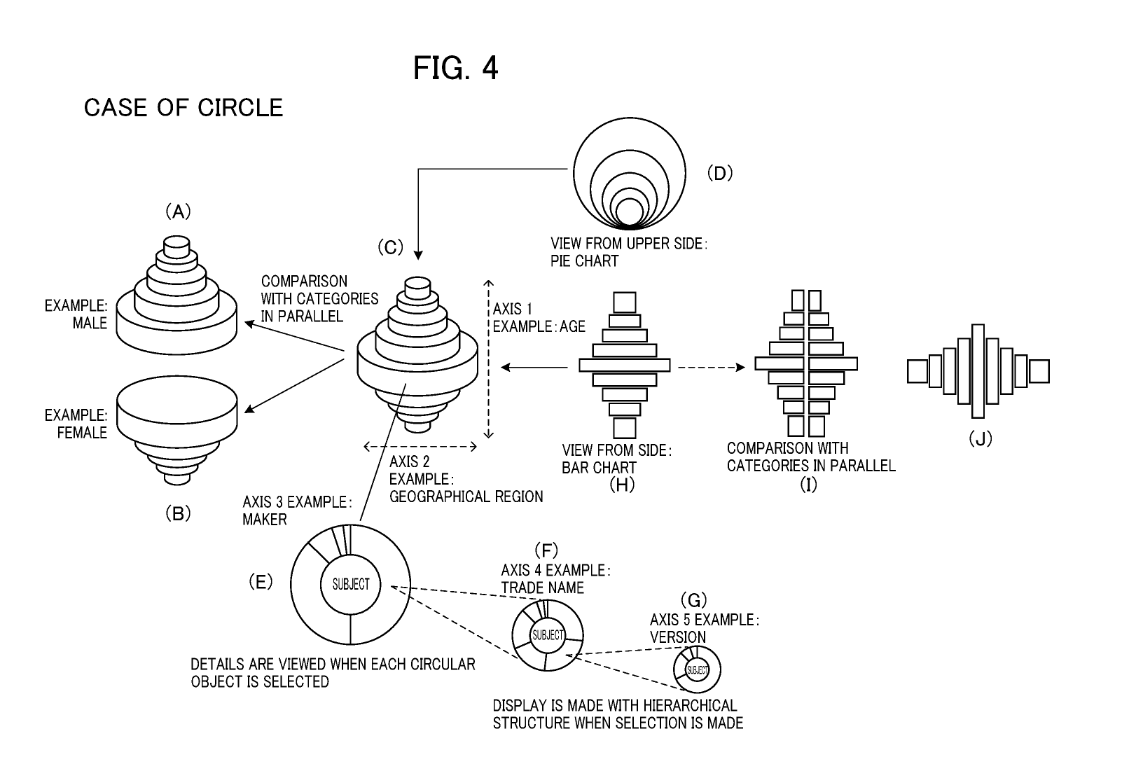

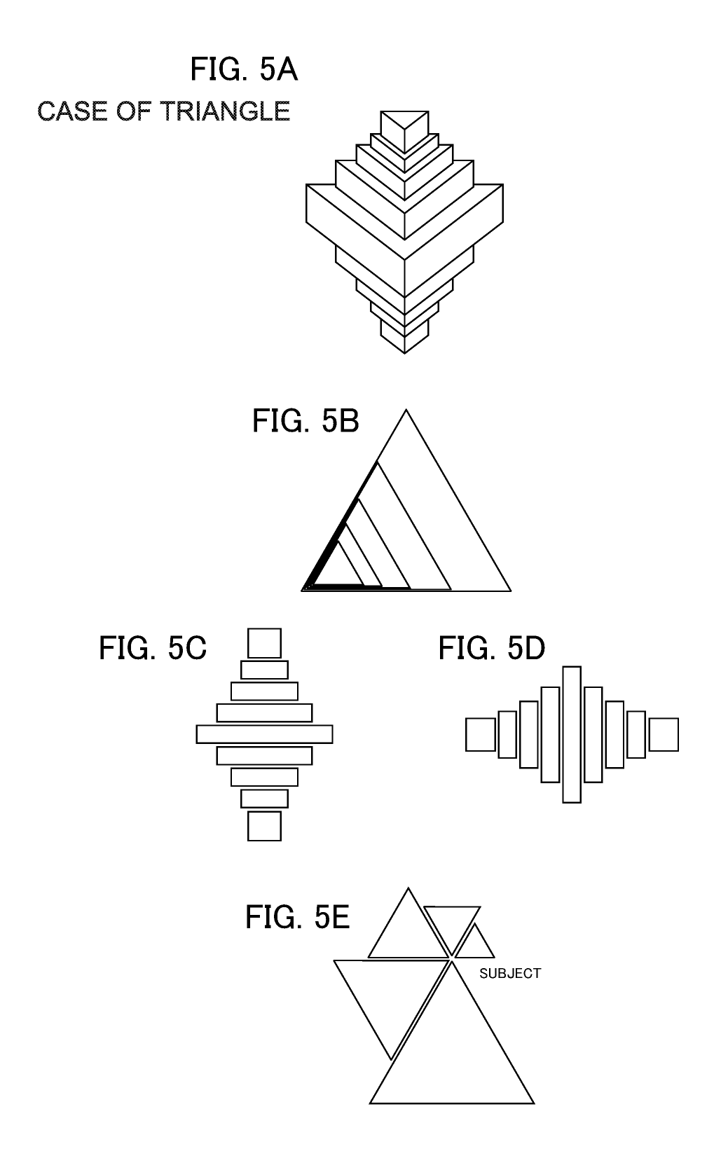

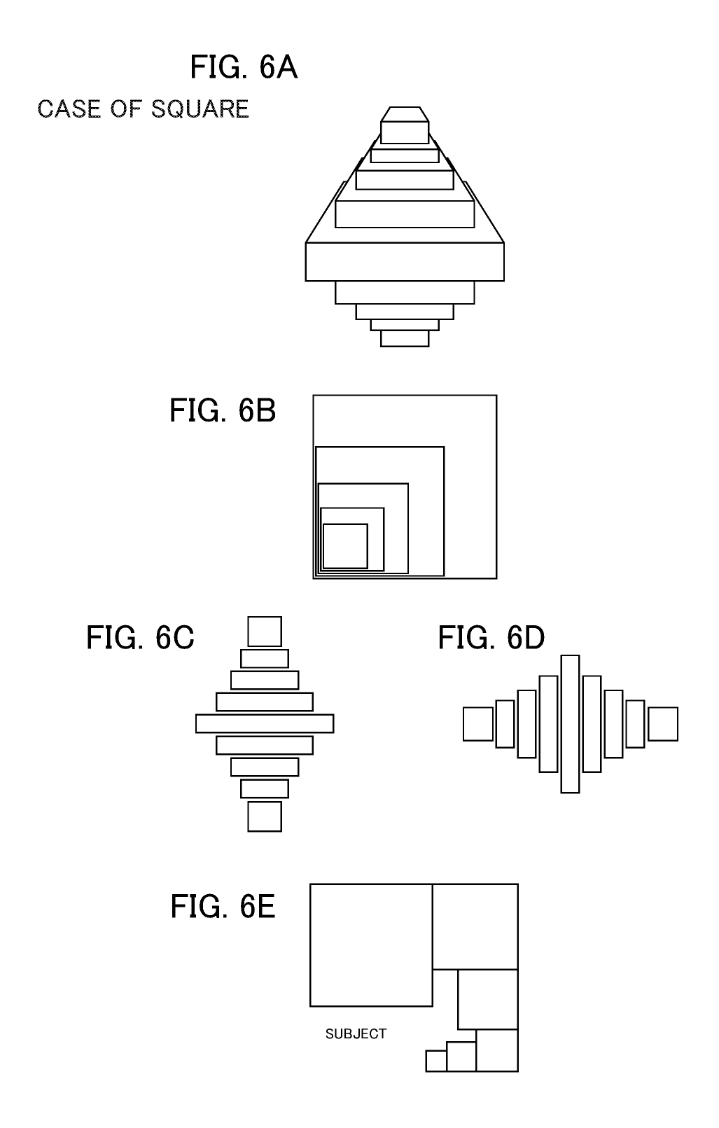

The iconization unit 42 iconizes the big data stored in the big data DB 51, automatically and in real time. Note that the big data iconized by the iconization unit 42 has been stored in the big data DB 51 as the example in FIG. 3, but is not particularly limited thereto and may be acquired at the time of the iconization. The data controller provision unit 43 provides the user terminal 1 of the user with the virtual data controller capable of controlling the big data with an interaction from the user with the icon, on the basis of the icon. In this case, the icon means data including raw data or intermediate data (text (numerical values included) data or graphic data) of the big data converted into a visible form (e.g., an illustration or a figure) that is different from the forms of the pieces of the data. The icon functions as at least one part of the virtual data controller. More specifically, the method of the iconization according to the present embodiment adopts, but is not particularly limited to, the following method. According to the present embodiment, a predetermined reference figure (e.g., circle in FIG. 4, triangle in FIGS. 5A to 5E, or square in FIGS. 6A to 6E) is defined. A method of combining and arranging the reference figure (hereinafter, referred to as a “combination and arrangement method”) is associated with each predetermined point of view or category (e.g., male/female, age, geographical region, maker, trade name, or version). According to the present embodiment, the reference figure is expressed as a 3D (or multidimensional) object that has been polygonized. Data (at least one of the objects) including at least one of the objects, combined and arranged in accordance with the combination and arrangement method, is adopted as the icon. Note that specific examples of the icon will be described later with reference to FIG. 4.

The method of the interaction from the user is not particularly limited. For example, if the location at which the icon is displayed is on the screen of a computer smart device (e.g., a smartphone) including a touch panel, an interaction b a touch operation, such as a click or a touch, can be adopted. More specifically, the user operation reception unit 44 receives the interaction as a user operation to supply the interaction to the data controller provision unit 43. The method of controlling the icon is not particularly limited. As an exemplary control, for example, designating an axis and an explanatory variable for totalization or analysis (the method and the like for designation designating them is not particularly limited) displays an analyzed result of the big data in terms of the axis and the explanatory variable that have been designated. In other words, when designation of is performed with the user terminal 1, the user operation reception unit 44 receives the designation as a user operation to supply the designation to the data controller provision unit 43. The data controller provision unit 43 performs control of displaying the analyzed result of the big data on the user terminal 1 in terms of the axis and the explanatory variable that have been specified.

More specifically, the iconization unit 42, for example, converts the data into a 3D (or multidimensional) polygon for each type (for each type, such as the points of view or the categories) to perform symbolic iconization including detailed data summarized (e.g., transformation into a button). Accordingly, the function of the virtual and simple data controller can be achieved in a manual operation.

The data controller provision unit 43 displays a plurality of polygonized objects (the aggregate of the plurality of objects constitute an icon) indicating a totalized result of the data for each type (for each type, such as the points of view explained above or categories) expressed in 3D (or multi-dimensions). The user uses the user terminal 1 to perform a rotational operation with the icon so that the icon can be viewed from a different viewpoint. In other words, on the basis of the operation performed by the user received by the user operation reception unit 44 (e.g., the rotational operation with the icon), the data controller provision unit 43 varies the viewpoint of the icon and then displays the icon on the user terminal 1 (displaying the rotated icon). More specifically, depending on the viewpoint (the angle in which the icon is viewed), for example, the icon that has been viewed as a “pie chart” is viewed as a “bar chart”. Thus, a plurality of expression methods can be achieved, with a single piece of polygon (the icon), on the screen of the computer smart device (e.g., a smartphone) constituted as the user terminal 1. In other words, the single piece (the icon) can express, for example, a plurality of two-dimensional graphs.

The description will be more specifically given with reference to FIG. 4. FIG. 4 is a diagram for specifically describing, with a case of the circle, the outline of the iconization of the data and the data controller function achieved by the server 2 according to the present embodiment.

The reference figure is the circle in FIG. 4, the graph (C) in FIG. 4 illustrates an exemplary icon.

In the example in FIG. 4, as illustrated in the graph (C) in FIG. 4, age is adopted as an axis 1, for example. The combination and arrangement method of layering the data for each age in the direction of the axis 1 is adopted. For example, geographical region is adopted as an axis 2, and the combination and arrangement method of layering the data for each geographical region in the direction of the axis 2 is adopted. In this case, the direction of the axis 1 is defined in the vertical direction, and the direction of the axis 2 is defined in the horizontal direction.

In this case, as illustrated in the graph (H) in FIG. 4, when the user views the icon from the side (when viewing the icon in a direction perpendicular to the axis 1), the icon expresses a bar chart. In this case, the user can compare the big data in terms of age. Furthermore, as illustrated in the graph (I) in FIG. 4, the bar chart in the same age group can be divided into different categories (geographical regions) so as to be arranged and displayed. In this case, the user can compare the big data in terms of two points of view including the age and the geographical region.

The user can flexibly move the icon in a direction in which it is easy to view the icon. For example, as illustrated in the graph (J) in FIG. 4, the icon can be moved to make the axis 1 in the horizontal direction.

Furthermore, as illustrated in the graph (D) in FIG. 4, when the user views the icon from the upper side (when viewing the icon in a direction perpendicular to the axis 2), the icon expresses a pie chart. In this case, the user can compare the big data in terms of distribution of the geographical region and the age.

As illustrated in FIG. 4, the combination and arrangement method is adopted in such a manner that big data relating to males is layered at one side in the direction of the axis 1 as a first category, and big data relating to females is layered at the other side in the direction of the axis 1 as a second category. In other words, the combination and arrangement method of arranging the categories, such as male and female, is adopted. The user compares the upper and lower sides so that the user can compare and examine the big data relating to the male and the big data relating to the female.

When the user selects a desired circular object from the circular objects included in the icon in the graph (C) in FIG. 4, the details of the data from which the circular object is originated can be viewed. In an example in the graph (E) in FIG. 4, one circular object is formed with the data for each age, relating to a predetermined subject. A graph relating to the predetermined subject is presented to the user. When the predetermined subject is defined to be an axis 3, for example, maker can be adopted as the axis 3. In this case, each item includes a hierarchical structure. More specifically, when the axis 3 is, for example, the maker, an axis 4 in the lower layer of the axis 3 represents, for example, trade name. An axis 5 in a further lower layer represents version. That is, when the user selects a predetermined item in the graph (E) in FIG. 4, as illustrated in the graph (F) in FIG. 4, a graph relating to a subject (trade name of the axis 4) in the lower layer of the item that has been selected, is presented to the user. Furthermore, when the user selects a predetermined item in the graph (F) in FIG. 4, as illustrated in the graph (G) in FIG. 4, a graph relating to a subject (version of the axis 5) in the lower layer of the item that has been selected, is presented to the user. In this manner, a graph is sequentially displayed according to the hierarchical structure every time the user selects an item.

Here, the icon in the graph (C) in FIG. 4 dynamically varies in shape on the basis of the amount, the type, or the size of the data, instead of being previously determined in shape. In other words, although not illustrated, for example, the user compares the icon at time t1 and the icon at time t2 so that the variation of the big data in a temporal direction can be easily viewed.

FIGS. 5A to 5E are diagrams for specifically describing, with a case of triangle, the outline of the iconization of the data and the data controller function, achieved by the server 2 according to the present embodiment.

The reference figure is the triangle in FIGS. 5A to 5E. FIG. 5A illustrates an exemplary icon. Here, the icon in the graph (C) in FIG. 4 and the icon in FIG. 5A may include the same big data or each may include different big data. That is, the same big data can be displayed in different expression forms, such as the circle and the triangle, or the big data is individually displayed in the different expression forms so that the types of (the entire) big data can be displayed. In this case, regardless of whether the big data is the same or not, each axis may be the same or each axis may be different from each other. That is, even when the big data is the same, for example, the axis 1 may represent the age in the case of the circle, and the axis 1 may represent the geographical region in the case of the triangle. Conversely, in a case where the circle is adopted for a first type of big data and the triangle is adopted for the second type of big data, for example, both of the axes 1 thereof may represent the age in a unified manner. Similarly, this feature can be applied to a case of the square described later with reference to FIGS. 6A to 6E in completely the same manner. Note that, in order to allow easy understanding of the present specification, the same combination and arrangement method is adopted and each axis is the same in FIGS. 4 to 6E.

FIG. 5B illustrates the icon in a case where it is viewed from the upper side, and corresponds to the graph (D) in FIG. 4. FIG. 5C illustrates the icon in a case where it is viewed from the side, and corresponds to the graph (H) in FIG. 4. FIG. 5D illustrates the icon in a case where an axis has been rotated, and FIG. 5D corresponds to the graph (J) in FIG. 4. FIG. 5E illustrates a graph illustrating the details in a case where any given object has been selected from the objects, and FIG. 5E corresponds to the graph (E) in FIG. 4. Note that, although not illustrated in FIGS. 5A to 5E, a graph is displayed with a hierarchical structure, as a result of selection of each item, similarly to FIG. 4.

FIGS. 6A to 6E are diagrams for specifically describing, with a case of the square, the outline of the iconization of the data and the data controller function, achieved by the server 2 according to the present embodiment.

The reference figure is the square in FIGS. 6A to 6E. FIG. 6A illustrates an exemplary icon, and corresponds to the graph (C) in FIG. 4. FIG. 6B illustrates the icon in a case where viewed from the upper side, and corresponds to the graph (D) in FIG. 4. FIG. 6C illustrates the icon in a case where viewed from the side, and corresponds to the graph (H) in FIG. 4. FIG. 6D illustrates the icon in a case where an axis has been rotated, and corresponds to the graph (J) in FIG. 4. FIG. 6E illustrates a graph illustrating the details in a case where an arbitrary object has been selected from the objects, and corresponds to the graph (E) in FIG. 4. Note that, as not illustrated in FIGS. 6A to 6E, a graph is displayed with a hierarchical structure, as a result of selection of each item, in a similar manner to the graphs (E) to (G) in FIG. 4.

As described above, with the user terminal 1, the user at least performs an intuitive and simple operation, such as a drag and drop operation, a click operation, or a touch operation, with respect to the object that has been polygonized (an exemplary icon or a constitutive element of the icon) as work for designating the totalization axis and the explanatory variable, in totalizing and analyzing of the big data.

The size and the shape of the data controller (the icon to be manipulated by the controller) can be changed according to the type, the size, and the contents of the big data to be used. That is, the dynamic controller is achieved. Therefore, the user compares and analyzes, for example, the shape of the controller object that has been polygonized (the icon or each constituent element included in the icon) so that comparison, abnormality detection, and analysis of classifications and the like can be performed even without the raw data (text data including numerical values or image data). Therefore, a vast number of computer resources are required in a case where analysis is performed with the raw data of the big data, but when the server 2 according to the present embodiment is used, the totalization and analysis can be performed with a considerably small number of computer resources.

Instead of downloading the raw data or the intermediate data of the big data stored in a server or in a storage in a data center connected through the network into the user terminal 1 (a digital terminal, such as a personal computer, a tablet, or a smartphone), the server 2 according to the present embodiment creates the icon having a small size, in comparison to the raw data (or the intermediate data), to allow the user terminal 1 to download the icon. Here, the icon has been regarded as the data that has been polygonized, in the example described above, but is not particularly limited thereto, and thus may be differential data, for example. Accordingly, this can reduce the time necessary for downloading and the burdening of the network resource. Data, such as personal information, is completely abstracted as the icon (or a part of the icon) so that security for data that is not desired to be presented is ensured. This is an useful form even in a case where data is exchanged and analyzed between different companies/organizations.

The server 2 according to the present embodiment can vary, for example, the shape of the controller object (the icon or a part of the icon) in real time according to the data changed, added, or updated in real time (or in a considerably short time). In this case, the variation of the shape over time can be expressed with animation. That is, the user simply performs a comparison by using, for example, 3D moving image data that has been animated, so that comparison and analysis in a temporal axis or simulation, such as future prospects, can be performed with the icon (e.g., a polygon object) as it is. That is, the user is not required to use the raw data and the intermediate data of the big data. Less computer resources is required. For example, the user at least uses the resource of a smartphone device. Accordingly, the comparison and analysis in the temporal axis in real time and the simulation, such as the future prospects, can be easily and simply performed. Note that the device according to the present embodiment can transform an analyzed result into raw data (intermediate data included). In this case, the device according to the present embodiment reversely converts the icon or a part of the icon (e.g., a polygon object) to generate the raw data (or the intermediate data).

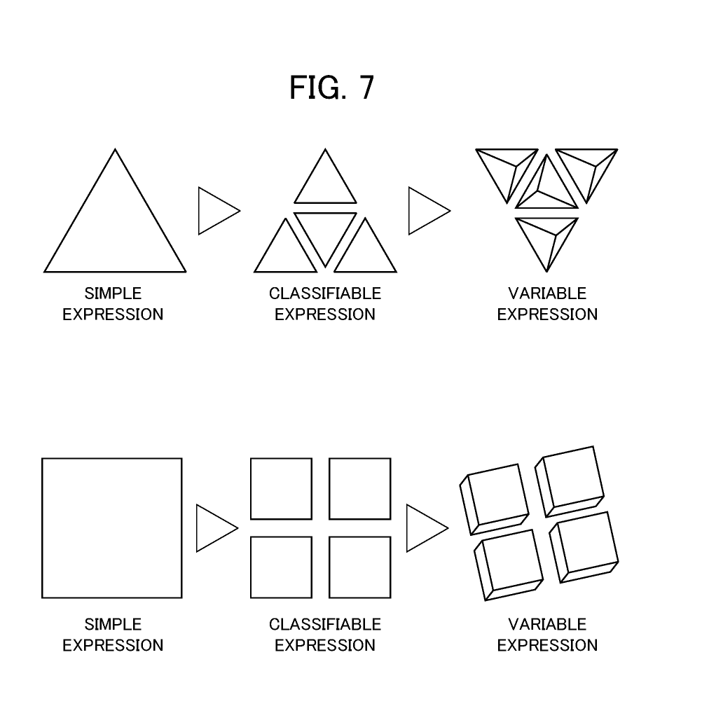

The processing in series described above may use any algorithm, but preferably uses machine learning or artificial intelligence (AI). FIG. 7 is a schematic diagram for indicating that analysis visualization by AI (artificial intelligence) allows more abstract graphics. Using AI allows the big data to be a simple expression, to be a classifiable expression, and furthermore to be a variable expression. FIG. 7 illustrates the drawings to sequentially vary to the three types of expressions. However, the three types of expressions does not need to be varied in this order. Thus, the variation from any given type of expression to another different type of expression can be flexibly performed. Mostly, the effects that can be achieved by the current machine learning and AI are often effective in a case of image (binary) data rather than in a case of text (digital) data. Therefore, using the icon in an image system according to the present embodiment (e.g., the object that has been polygonized in the image system) for analysis with AI contributes more greatly to the industry.

The processing in series described above can be performed with either hardware or software.

In a case where the series of processing is performed by software, a program included in the software is installed from the network or a recording medium into a computer. The computer may be a computer built in dedicated hardware. The computer may be, for example, not only a server but also a general-purpose personal computer capable of performing various functions with the installation of various programs.

The recording medium including the program is not only constituted by a removable medium, not illustrated, distributed separately from the device body, but also constituted by a recording medium and the like provided to the user in such a manner that it is previously built in the device body in order to provide the user with the program.

Note that, in the present specification, the steps describing the program recorded in the recording medium includes not only processing performed in the chronological order according to the order of the steps but also processing performed in parallel or individually that is not necessarily processed in the chronological order.

1. An information processing device comprising:
an iconization unit configured to make big data into an icon; and
a data controller provision unit configured to provide a virtual data controller to a terminal of a user, the virtual data controller configured to control the big data with an interaction from the user with the icon,
wherein the icon is data obtained by converting raw data or intermediate data of the big data into a visible form that is different from the form of the big data, and is data made by combining at least one or more objects obtained by making a reference figure polygonized into multidimension.

2. The information processing device according to claim 1, wherein the reference figure is a circle, a triangle, or a square,
the icon is data made by combining the reference figure in accordance with a combination and arrangement method, and
the combination and arrangement method is a method of combining the reference figures in accordance with predetermined point of view or category.

3. The information processing device according to claim 1, wherein the interaction with the icon is a drag and drop operation, a click operation, or a touch operation within a screen.

4. The information processing device according to claim 1, wherein the data controller provision unit displays, as the icon, a plurality of polygonized objects indicating a totalized result of the big data expressed in multi-dimensions, and
when the user performs, as the interaction with the icon, a rotational operation with the icon, the data controller provision unit displays the icon upon changing a viewpoint.

5. The information processing device according to claim 4, wherein each of the plurality of objects has a cylindrical shape,
the plurality of objects are stacked in a first direction,
when the user sees the plurality of objects from a second direction perpendicular to the first direction, the plurality of objects appear to be a bar chart, and
when the user sees the plurality of objects from the first direction, the plurality of objects appear to be a pie chart.

6. The information processing device according to claim 5, wherein the objects based on a first category are stacked toward one side of the first direction, and
the objects based on a second category are stacked toward the other side of the first direction.

7. A non-transitory computer readable recording medium storing a program for causing a computer to execute:
making big data into an icon; and
providing a virtual data controller to a terminal of a user, the virtual data controller configured to control the big data with an interaction from the user with the icon,
wherein the icon is data obtained by converting raw data or intermediate data of the big data into a visible form that is different from the form of the big data, and is data made by combining at least one or more objects obtained by making a reference figure polygonized into multidimension.

8. The non-transitory computer readable recording medium according to claim 7, wherein the reference figure is a circle, a triangle, or a square,
the icon is data made by combining the reference figure in accordance with a combination and arrangement method, and
the combination and arrangement method is a method of combining the reference figures in accordance with predetermined point of view or category.

9. The non-transitory computer readable recording medium according to claim 7, wherein the interaction with the icon is a drag and drop operation, a click operation, or a touch operation within a screen.

10. The non-transitory computer readable recording medium according to claim 7, wherein in the step of making the big data into the icon, a plurality of polygonized objects indicating a totalized result of the big data expressed in multi-dimensions are displayed as the icon, and
when the user performs, as the interaction with the icon, a rotational operation with the icon, the icon is displayed with a change in a viewpoint in the step of providing the data controller to the user.

11. The non-transitory computer readable recording medium according to claim 10, wherein each of the plurality of objects has a cylindrical shape,
the plurality of objects are stacked in a first direction,
when the user sees the plurality of objects from a second direction perpendicular to the first direction, the plurality of objects appear to be a bar chart, and
when the user sees the plurality of objects from the first direction, the plurality of objects appear to be a pie chart.

12. The non-transitory computer readable recording medium according to claim 11, wherein the objects based on a first category are stacked toward one side of the first direction, and
the objects based on a second category are stacked toward the other side of the first direction.

13. A non-transitory computer readable recording medium comprising:
making big data into an icon; and
providing a virtual data controller to a terminal of a user, the virtual data controller configured to control the big data with an interaction from the user with the icon,
wherein the icon is data obtained by converting raw data or intermediate data of the big data into a visible form that is different from the form of the big data, and is data made by combining at least one or more objects obtained by making a reference figure polygonized into multidimension.
